(19) United States
(12) Patent Application Publication
(10) Pub. No.: US 2008/0282937 A1
(43) Pub. Date: Nov. 20, 2008

(54) Compositions of and methods for making of a concrete-like material containing cellulosic derivatives

(76) Inventors: Mason Baker, Oxford, MS (US); John Everett Mulder, JR., Auburn, CA (US)

Correspondence Address: TERRY B. MORRIS, P.O. BOX 1993, PRAIRIEVILLE, LA, 70769, US

(21) Appl. No.: 11/804,530

(22) Filed: May 18, 2007

(51) Int. Cl. C04B 7/02; C04B 16/02

(52) U.S. Cl. 106/724; 106/802

(57) ABSTRACT

This invention is a composition comprising an admixture of one or more cementitious component(s) and one or more cellulosic component. The cellulosic components comprise a defined size and a defined aspect ratio and an amount of water which is within a range effective to impart characteristic in a final hardened product. Importantly, the present invention allows the reduction/elimination of the aggregate and sand content of concrete and similar material without loss of associated properties. Unexpectedly, there are significant improvements of some of the properties.

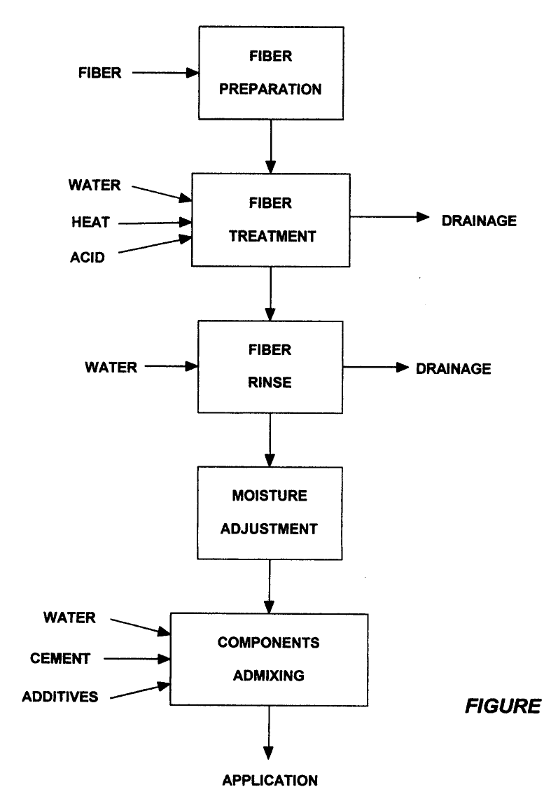

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL ON A COMPACT DISC

Not Applicable.

### BACKGROUND OF THE INVENTION

(1) Field of the Invention

This invention relates to compositions and methods of making such compositions which are cementitious-type material. More particularly, the invention relates to cementitious materials having reactants therein derived from cellulosic matter and which can omit from the composition the use of gravel, sand and other additives typical for concrete.

(2) Description of Related Art

Concrete and other material produced from cementitious based components are the ubiquitous material used in the construction industry. The versatility of such material is that it can be prepared prior to the construction process or as a part of it. Among the features sought in such material are flowability prior to hardening to facilitate placement, compression or flexural strength in final state, weight of material, capability to integrate additives which provides additional characteristics, cost and availability of components, porosity of formed material, handling of formed material and suitability to perform additional construction processes to it.

Concrete typically is a conglomerate of aggregate imbedded in a matrix of either mortar or cement, which sets to a hard infusible solid on standing by either hydraulic action or by chemical cross-linking. Examples of aggregate are gravel, pebbles, sand, broken stone, blast-furnace slag, cinders, and the like. Examples of mortar are materials made with cement, lime, silica, sulfur, and sodium or potassium silicate, and the like.

Typical of cements is the standard Portland cement, which is a type of hydraulic cement in the form of finely divided, gray powder composed of lime, alumina, silica, and iron oxide as tetracalcium aluminoferrate, tricalcium aluminate, tricalcium silicate and dicalcium silicate. A hydraulic cement will set by admixture with water which combines chemically to form a hydrate. Additives may also be present to improve adhesion, strength, flexibility, and curing properties. Hardening does not require air and will occur under water. Water evaporation can be retarded by adding such resins as methylcellulose and hydroxyethylcellulose.

A particular function of aggregate in concrete is to bring strength to the hardened concrete and early resistance to flow while the hardening process is occurring. It can also function as a simple filler to reduce the cement values.

Attempts to bring innovation to the concrete and related cement based technologies have included efforts to find a use for fibrous materials as an additive or as a substitute for aggregate. The fibrous material have included both organic and inorganic fibers and both natural and man-made fibers.

In U.S. Pat. No. 6,872,246, the use of cellulosic material as a filler or extender for hydraulic cement compositions is disclosed. Pertinent portions of this reference provided the following:

“The use of fillers or extenders gives rise to new cement compositions having unique and advantageous qualities, in addition to extending the coverage of the cement composition, and, where the filler has a low density, in making light-weight cement based compositions and products. However the use of such cellulosic material often retards cementitious compositions resulting in products having lower strength, poorer keeping qualities by being susceptible to rotting and degradation, and lower impact resistance. Portland cement bonded lignocellulosic materials are known to have a detrimental effect on the strength and quality of cement compositions. Typical lignocellulosic materials which cause retardation include various wood particles such as rice husks, jute sticks, coir, sawdust, coconut pith, banana stem fiber and wheat straw. It is thought that in the setting of cement-wood particle compositions that a weak boundary layer is formed between the calcium silicate hydrate and the wood particles as a result of the dissolution of polysaccharide and lignin released during the setting of the cement by calcium hydroxide. The addition of wood particles to cement compositions gives rise to weak and inferior products as a result of the poor adhesive forces operating between wood particles and the hydrated products of cement [see Singh, S. M., R Indian Acad. Wood Sci., 10 (1) p 15-19 (1979)].

“However, cellulose fiber cement materials can have performance drawbacks such as lower resistance to water induced damages, higher water permeability, higher water migration ability (also known as wicking) and lower freeze thaw resistance when compared to asbestos cement composite material. These drawbacks are largely due to the presence of water conducting channels and voids in the cellulose fiber lumens and cell walls. The pore spaces in the cellulose fibers can become filled with water when the material is submerged or exposed to rain/condensation for an extended period of time. The porosity of cellulose fibers facilitates water transportation throughout the composite materials and can affect the long-term durability and performance of the material in certain environments. As such, conventional cellulose fibers can cause the material to have a higher saturated mass, poor wet to dry dimensional stability, lower saturated strength, and decreased resistance to water damage.

“The high water permeability of the cellulose reinforced cement materials also results in potentially far greater transport of some soluble components within the product. These components can then re-deposit on drying, either externally, causing efflorescence, or internally, in capillary pores of the matrix or fiber. Because the materials are easier to saturate with water, the products also are far more susceptible to freeze/thaw damage. However, for vertical products, or eaves and soffit linings, and for internal linings, none of these water-induced disadvantages are very relevant.

“For example, U.S. Pat. No. 5,021,093 teaches grafting a silyating agent to the fiber surface so as to improve the strength of the resulting composite material. The silyating agent comprises molecules containing hydrophilic groups on both ends so that one end can bond with hydroxyl groups on the fiber surface and the other end can bond with the cementitious matrix. The silyating agent essentially serves as a coupling agent that connects hydroxyl groups on the fiber surface to the cementitious matrix.

“U.S. Pat. No. 4,647,505 teaches applying a chelating agent to a cellulose fiber to reduce fiber swelling in aqueous and alkaline solutions. The fibers are impregnated with a solution of a titanium and/or zirconium chelate compound. The chelate compound, however, does not react upon contact with the fiber, because the fiber is contained in an aqueous medium, and the chelate compounds described in the patent resist hydrolysis at ambient temperatures. Therefore, this patent describes heating the fibers above 100.degrees Centigrade to dry the fibers, thereby allowing the reaction to take place. After drying, the chelate compound(s) react with hydroxyl groups on the cellulose fibers to produce cross-linking between the hydroxyl group residues.

“As U.S. Pat. No. 4,647,505 is directed primarily to reducing swelling of cellulose fibers, it is not specifically directed to increasing hydrophobicity of the fibers. Moreover, this patent provides an approach to fiber treatment which requires drying of the fibers in order to induce reaction with the cellulose fibers.”

The solution provided by U.S. Pat. No. 6,872,246 is chemically treating cellulose fibers to impart the fibers with hydrophobicity and/or durability, and making cellulose fiber reinforced cement composite materials using these chemically treated cellulose fibers. In one preferred embodiment of U.S. Pat. No. 6,872,246, the cellulose fibers are treated or sized with specialty chemicals that impart the fibers with higher hydrophobicity by partially or completely blocking the hydrophilic groups of the fibers. However, other embodiments for chemically treating the fibers are also disclosed, including loading or filling the void spaces of the fibers with insoluble substances, or treating the fibers with a biocide to prevent microorganism growth or treating the fibers to remove the impurities, and perform other functions.

There remains a need to find a cement derived material which can incorporate fibrous material. In particular, there is a need to find such a material which can allow the reduction of the aggregate content while maintaining or improving the properties of the material, such as compression or flexural strength in concrete and other characteristics.

### BRIEF SUMMARY OF THE INVENTION

The present invention allows the substitution in whole or in part of the aggregate and sand content of concrete and similar material without loss of associated properties. Unexpectedly, there are significant improvements of some of the properties, as hereinafter described.

An object of the present invention is to provide a material that can be used in place of and instead of concrete, mortar, and similar cementitious-type materials presently used in the construction and other industries. Another object is to achieve such replacement without loss of strength or other favorable properties.

Accordingly, a list of independent and codependent objects of the present invention includes, but is not limited to, the attainment of a concrete-like or cementitious-like material with the following characteristics:

high compression strength;

high early compression and flexural strength with or without accelerated curing or fast cements;

ductility, particularly with high flexural strengths;

working characteristics similar to wood in being nailable, screwable, and cuttable using tools with which to do the same work with wood;

machinability, such as being susceptible to turning screw threads and hand tapping;

fireproof;

termite and dry-rot proof;

lightweight, even buoyant in water;

thermal insulating;

negligible shrinkage in drying; and

directly substitutable for concrete, being workable in the same equipment as used for concrete operations, such as rotary drum delivery trucks, pumping systems and forms.

These and other objects are achievable in the practice of he present invention herein. Unexpectedly, many of the properties of the current invention not only match, but favorably exceed that of standard concrete.

### BRIEF DESCRIPTION OF THE SEVERAL VIEWS OF THE DRAWING(S)

Depicted in the accompanying FIGURE is a flow chart of one method of making the compositions of the present invention.

### DETAILED DESCRIPTION OF THE INVENTION

One embodiment of the present invention is a composition comprising an admixture of a cementitious component and a cellulosic component. The cellulosic fibrous material has a defined size and a defined aspect ratio. A controlled amount of water is associated with the cellulosic fibrous material, as described hereinafter in detail. This water content is defined separately from the amount of water added to instigate the reaction of materials in the composition to form a hardened product with the admixture.

The cementitious material can be that typically used in the concrete, mortar, cement and related cement-derived material industry. The cementitious component preferably is a mortar or a hydraulic cement, more preferably a Portland cement. The cementitious component may also contain additional components, such as a gravel and/or a sand, as well as an optional accelerant to assist in the hardening process. As described hereinafter, such additional components are not necessarily needed for a variety of the compositions and of the applications.

The cellulosic material can be that generally containing a natural carbohydrate high polymer (polysaccharide) consisting of anhydroglucose units joined by an oxygen linkage to form essentially linear, long molecular chains. The degree of polymerization can range from 1000, as in wood, to 3500, as in cotton fiber, and typically have a molecular weight from 160,000 to 560,000. Typical sources are wood, paper, pulp, cotton products, biomasses, and plant portions, such as grain hulls, preferably exemplified by rice.

Generally speaking, the cellulosic fibrous material may be prepared from cellulose fibers from synthetic sources or sources such as woody and non-woody plants. Woody plants include, for example, deciduous and coniferous trees. Non-woody plants include, for example, cotton, flax, esparto grass, milkweed, straw, jute, hemp, and bagasse. The cellulose fibers may be modified by various treatments such as, for example, thermal, chemical and/or mechanical treatments. It is contemplated that reconstituted and/or synthetic cellulose fibers may be used and/or blended with other cellulose fibers of the cellulosic fibrous material. Cellulosic fibrous materials may also be composite materials containing cellulosic fibers and one or more non-cellulosic fibers and/or filaments. A synthetic source example is recycled paper.

Preferred sources of cellulosic material are sugar canes, corn husks, wood chips and wood pulps.

Other preferred sources of cellulosic fibrous materials are cellulosic hulls. Preferred hulls are cotton hulls, grain hulls, nut hulls, and rice hulls.

While not wishing to be limited by theory, it is believed that the current invention has results, at least in part possibly, on the transport phenomenon during the hydration reaction of the cementitious material, which in the case of the present invention also involves a reaction between the composition chemicals of the cementitious materials and that of the cellulosic fiber or fiber fragment. The range of the fiber moisture is believed critical in that the fibers must be sufficiently moist to prevent too much water absorption during the hydration process from the fiber into the adjacent cementitious material, and also not too wet to prevent the bonding/reacting of the fiber material and cementitious material, allowing transport of material onto and into the fiber material for reactions. Observation of the hardened material of the present invention can allow one description of the interface of the fiber-cementitious material bond as being analogous to the weld zone observed in metallic welds. This differs from the encasement or encapsulation of fiber materials which can be often viewed in prior fibrous cement compositions. Also a factor is the size and shape of the cellulosic fibrous material, such having impact not only on the chemical reactions during hardening but also on the resulting strength and other performance parameters of the hardening and hardened product. This theory is not exclusive as other physical and chemical phenomena may also be occurring as well.

One embodiment of the present invention is a composition comprising an admixture of one or more cementitious component(s) and one or more cellulosic component(s). The cellulosic components comprise one or more cellulosic fibrous material(s) having a defined size and a defined aspect ratio, and a first amount of water associated with the cellulosic fibrous material(s).

The admixture is suitable for mixing with a second amount of water to form a hardened product.

In a preferred embodiment, the defined size, defined aspect ratio and said first and second amounts of water are effectively controlled such that said hardened product has a compression test value of at least about 2,000, more preferably at least about 2,900, pounds of pressure per square inch as measured within seven days.

In one embodiment of the present invention, the cellulosic fibrous material has a preferred length of about 0.1 centimeters to about 2.0 centimeters, more preferably about 0.5 centimeters to about 1.0 centimeters. Even longer or shorter lengths are useable, but the shorter values generally are to be favored initially.

In yet another embodiment of the present invention, the cellulosic fibrous material has an aspect ratio of about 1.0 to about 0.05.

In yet another embodiment of the present invention, the cellulosic fibrous material has a particle size distribution with controlled head and tail portions. These portions can be screened in accordance with their impact on the performance of the composition.

In yet another embodiment of the present invention, the water associated with said cellulosic fibrous material is from about 20 percent to about 45 percent, more preferably about 35 percent to about 40 percent, as measured by weight of water to weight of water and cellulosic fibrous material combined. The specific amount will vary according to conditions of the materials used and other factors discussed herein, and may be determined by consideration of material testing on the intermediate product or on the final hardened product, such as compression test and other similar tests.

In yet another embodiment, the present invention is a composition comprising the hardened product of the admixture after the reaction between the cement portion and the cellulosic portion.

In yet another embodiment of the present invention, the composition comprises an admixture of one or more cementitious component and one or more cellulosic component. The cellulosic component comprises one or more cellulosic fibrous material having a defined size and a defined aspect ratio, and a first amount of water associated with said cellulosic fibrous material. The formed admixture is suitable for mixing with a second amount of water to form a hardened product. The defined size, defined aspect ratio and said first and second amounts of water are effectively controlled such that said hardened product has a compression test value greater than that of a comparison composition comprising equivalent amounts of said cementitious component, said first and second amounts of water and a volume of sand and aggregate equal to the volume of said cellulosic material.

In a preferred embodiment of the present invention, the composition just described has a compression test value at least about ten per cent greater, more preferably at least about twenty-five per cent greater, than of the comparison composition.

In another preferred embodiment, in the composition just described the defined size, defined aspect ratio and said first and second amounts of water are effectively controlled such that said hardened product has a weight of at most about 75% of said comparative composition. In some embodiment, such as those wherein the cellulosic material is about 50% of the weight of the total admixture, the final hardened product is buoyant.

In yet another embodiment the defined size, defined aspect ratio and said first and second amounts of water are effectively controlled such that said hardened product has a porosity of at most about 75% of said comparative composition.

In a preferred embodiment the defined size, defined aspect ratio and said first and second amounts of water are effectively controlled such that said hardened product has a weight of at most about 75% of said comparative composition, a porosity of at most about 75% of said comparative composition, and a compaction test value of at least 50% greater than that of said comparative composition.

In another embodiment, the present invention is a method comprising the following steps:

(a) a preparation step comprising reduction of a cellulosic fiber material to produce a fiber fragment product;

(b) a treatment step comprising
(1) admixing said fiber fragment product and water to form an admixture,
(2) heating said admixture,
(3) agitating said admixture,
(4) optionally acid-treating said admixture, and
(5) separating a treated fiber fragment product from said admixture; and

(c) a rinsing step comprising rinsing said treated fiber fragment product with water to form a rinsed fiber fragment product.

It is understood that the heating of the admixture in step (b)(2) can be reduced or eliminated and the water is step (b)(1) can be first heated prior to admixing.

In a preferred embodiment, the steps are effectively controlled so that said rinsed fiber fragment product is suitable for reacting with a cementitious composition to form a product having a compression strength at least equal to about 2,000, more preferably about 2,900, pounds per square inch after seven days.

The accompanying FIGURE depicts a flow chart of one embodiment of the invention herein. It is to be appreciated that the method depicted illustrates not only the making of the inventive composition of treated fiber material, but also a method of the production of a cementitious material incorporating such treated fiber material.

In the FIGURE there is depicted five stages of operations: FIBER PREPARATION, FIBER TREATMENT, FIBER RINSE, MOISTURE ADJUSTMENT, AND COMPONENTS MIXING. It is noted that the stages of FIBER TREATMENT, FIBER RINSE and MOISTURE ADJUSTMENT may be performed in the same equipment or separate equipment and during overlapping times of operation.

In the FIBER PREPARATION stage, a cellulose containing material is subjected to grinding to break down the superficial structure and to perform some amount of defibrillation, if possible. As a non-limiting illustration, rice hull is subjected to grinding using a conveniently available machine to reduce the rice hull into fragments of less than one-half of an inch, preferably less than one-eighth of an inch. The fragments are then provided to the FIBER TREATMENT stage.

In the FIBER TREATMENT stage, the fiber fragments are subject to agitation in water. The desired result is cleaning of the fiber fragment of debris which can interfere with the fiber fragment reaction with cement. Preferably, the water is heated with a high temperature approaching boiling being preferred. To assist in the treatment, an acidic component may be added which helps to clean the fragments or facilitate fragmentation. After treatment, the excess fluids are drained through filters and the treated fiber fragments are provided the FIBER RINSE stage.

In the FIBER RINSE stage, the treated fiber fragments are rinse with water in a batch or continuous manner to further remove debris from the fragments. One or more rinse cycles may be necessary to achieve a fiber fragment which will perform to the desired specification in the compositions The fragments are then provided to the MOISTURE ADJUSTMENT stage.

In the MOISTURE ADJUSTMENT stage, the fiber is analyzed for moisture content and it is determined whether the moisture content is satisfactory or in need of adjustment. The determination to make adjustments can be based, at least in part, upon the performance of the composition achieved after mixing with cement in the intended application. This can be based, for examples, upon either pre-existing specifications which set the moisture content range or upon data in the field providing performance feed-back indicating the need for moisture adjustment. Naturally, moisture content may be varied depending upon the fiber type selection or mix, degree of grinding, fiber batch performance, ambient humidity and temperatures, and cement type. Other considerations may also be made, such as standing time, additional additives to the mix and the like. As discussed elsewhere, the moisture content of the treated fiber fragment is controlled to achieve the intended reaction results with the cement used.

After any moisture adjustments, the fiber fragments are then subjected to the COMPONENTS ADMIXING stage, in which the cement or cement-like reactant is admixed with the treated fiber fragments and appropriate amounts of water and additives, if any, to induce start of the hardening process. The method of and energy applied to the admixing stage can vary according to the desires of the application. Naturally, the fiber moisture should be preserved until admixing occurs or any changes in moisture content anticipated and adjusted for in the MOISTURE ADJUSTMENT stage.

For instance, mixing can be performed in a fixed equipment operation and the produced cementitious product provided to an application. One non-limiting example would be in a manufacturing facility in which the cementitious material is being cast for production of a product, such as siding for a house or a railroad tie.

In another illustrative instance, the mixing can be performed in a typical cement truck in which mixing occurs before, during or after transportation to a pour site for application of the admixture.

Other mixing equipment can be used, such as high speed centrifugal mixers, for example. One advantage of the present inventive composition is that it can in essence be substituted in place of presently available concrete not only in use but in the equipment used to apply concrete.

In yet another embodiment, the present invention is a method which extends the foregoing method described in paragraph [0045] by the addition of the following step:

(d) a mixing step comprising
(1) creating an admixture of said rinsed fiber fragment product, a cementitious binder, and water; and
(2) mixing said admixture to produce a mixed mass.

This method can then be extended to include sequentially adding a reaction step comprising reacting said mixed mass to create a product comprising reacted rinsed fiber fragment product and cementitious binder.

Various embodiments of the present invention are depicted in the following examples.

### EXAMPLE 1

Cylinder strength tests were performed on compositions of materials made in accordance with the present invention. The materials were formed into cylinders of 4 inches diameters and 8 inches of length and tested on a Service Physical Tester, Model PCHD 250 Concrete Tester. The following results were obtained:

First Composition Test Series

| Sample | Cylinder Age | Total Load | Unit Load |
|---|---|---|---|
| Number | (Days) | (Pounds) | (Pounds per Square Inch) |
| 1-1 | 6 | 42,500 | 3,381 |
| 1-2 | 6 | 44,500 | 3,500 |
| 1-3 | 6 | 48,500 | 3,858 |
| 1-4 | 6 | 45,000 | 3,579 |
| 1-5 | 28 | 49,000 | 3,898 |

Second Composition Test Series

| Sample | Cylinder Age | Total Load | Unit Load |
|---|---|---|---|
| Number | (Days) | (Pounds) | (Pounds per Square Inch) |
| 2-1 | 7 | 46,000 | 3,659 |
| 2-2 | 7 | 39,500 | 2,387 |
| 2-3 | 8 | 71,500 | 5,688 |
| 2-4 | 9 | 30,000 | 2,387 |
| 2-5 | 9 | 47,500 | 3,779 |
| 2-6 | 9 | 23,000 | 1,830 |
| 2-7 | 9 | 53,500 | 4,256 |

Third Composition Test Series

| | Cylinder | | Unit Load |
|---|---|---|---|
| Sample | Age | Total Load | (Pounds per |
| Number | (Days) | (Pounds) | Square Inch) |
| 3-1A | 7 | 45,500 | 3,619 |
| 3-1B | 7 | 52,000 | 4,136 |
| 3-1 | 14 | 64,000 | 5,091 |
| 3-1 | 28 | 60,500 | 4,813 |
| 3-2A | 7 | 52,000 | 4,136 |
| 3-2B | 7 | 55,000 | 4,378 |
| 3-2 | 14 | 58,000 | 4,614 |
| 3-2 | 28 | 62,000 | 4,932 |

It is to be noted that Sample 2-2 was made with a weight proportion of about 7.5 pounds cement to 3.2 pounds of wet fiber and 78 ounces of water added to make the sample. It is further noted that Sample 2-3 was made with a proportion of 2 volume units of cement to 1 volume unit of inventive fiber at 45% moisture by weight. The remaining samples were generally about 5 volume units of cement to 1 volume unit of fiber. The results attained were achieved by varying the fluids in the fiber prior to mixing with the cement and varying the amount of water added to the mixture of fiber and cement and are provided here to exemplify the general nature of such results achievable.

### EXAMPLE 2

Two samples of the inventive composition, A and B respectively, were made using the following formulation for each cubic yard of sample:

| | |
|---|---|
| 10 bags cement | 940 pounds |
| water | 480 pounds |
| inventive treated fiber | 240 pounds |

Sample A was mixed in a typical truck barrel mixer as used in conventional “ready mix” operations. The barrel mixer operated at a rotation speed of about 1,600 revolutions per minute. Sample B was mixed in a high speed vertical mixer at a rotation speed of about 3,000 to 6,000 revolutions per minute for a similar length of time.

Standard compression test after 30 days as for a concrete test cylinder produced the following results:

| Sample | Compression Strength (psi) |
|---|---|
| A | 5,000 to 7,000 |
| B | 7,000 to 12,000 |

Although the invention has been described with reference only to selected examples, it will be appreciated by those skilled in the art that the invention may be embodied in many other forms.

What is claimed is

1. A composition comprising an admixture of
(1) one or more cementitious component(s) and
(2) one or more cellulosic component(s) comprising
(a) one or more cellulosic fibrous material(s) having a defined size and a defined aspect ratio, and
(b) a first amount of water associated with said cellulosic fibrous material(s);
wherein said admixture being suitable for mixing with a second amount of water to form a hardened product and
wherein said defined size, defined aspect ratio and said first and second amounts of water are effectively controlled such that said hardened product has a compression test value of at least about 2,000 pounds of pressure per square inch as measured within seven days.

2. The composition of claim 1 further comprising said second amount of water.

3. The composition of claim 1 wherein said cementitious component comprises a mortar.

4. The composition of claim 1 wherein said cementitious component comprises a hydraulic cement.

5. The composition of claim 4 wherein said cementitious component comprises a Portland cement.

6. The composition of claim 1 wherein said cementitious component comprises a gravel.

7. The composition of claim 1 wherein said cementitious component comprises a sand.

8. The composition of claim 1 wherein said cementitious component comprises an accelerant.

9. The composition of claim 1 wherein said cellulosic fibrous material is from a woody plant.

10. The composition of claim 9 wherein said cellulosic fibrous material is a wood chip.

11. The composition of claim 1, wherein said cellulosic fibrous material is from a non-woody plant.

12. The composition of claim 1 wherein said cellulosic fibrous material is from bagasse.

13. The composition of claim 1 wherein said cellulosic fibrous material is from a cellulosic hull.

14. The composition of claim 1 wherein said cellulosic fibrous material is from a cellulosic hull selected from the group consisting of a cotton hull, a grain hull, and a nut hull.

15. The composition of claim 1 wherein said cellulosic hull is a grain hull.

16. The composition of claim 15 wherein said cellulosic hull is a rice hull.

17. The composition of claim 9 wherein said cellulosic fibrous material is wood pulp

18. The composition of claim 1 wherein said cellulosic fibrous material has a length of about 0.1 centimeters to about 2.0 centimeters.

19. The composition of claim 19 wherein said cellulosic fibrous material has a length of about 0.5 centimeters to about 1.0 centimeters.

20. The composition of claim 1 wherein said cellulosic fibrous material has an aspect ratio of about 1.0 to about 0.05.

21. The composition of claim 1 wherein said cellulosic fibrous material has a particle size distribution with controlled head and tail portions.

22. The composition of claim 1 said first amount of water associated with said cellulosic fibrous material is from about 20 percent to about 40 percent, as measured by weight of water to weight of water and cellulosic fibrous material combined

23. The composition of claim 2 wherein said admixture and said second amount of water have reacted to form a hardened state.

24. A composition comprising an admixture of
(1) one or more cementitious component and
(2) one or more cellulosic component comprising
(a) one or more cellulosic fibrous material having a defined size and a defined aspect ratio, and
(b) a first amount of water associated with said cellulosic fibrous material;
wherein said admixture being suitable for mixing with a second amount of water to form a hardened product and
wherein said defined size, defined aspect ratio and said first and second amounts of water are effectively controlled such that said hardened product has a compression test value greater than that of a comparison composition comprising equivalent amounts of said cementitious component, said first and second amounts of water and a volume of sand and aggregate equal to the volume of said cellulosic material.

25. The composition of claim 24 having a compression test value at least about ten per cent greater than of said comparison composition.

26. The composition of claim 24 having a compression test value at least about twenty-five per cent greater than of said comparison composition.

27. The composition of claim 24 wherein said defined size, defined aspect ratio and said first and second amounts of water are effectively controlled such that said hardened product has a weight of at most about 75% of said comparative composition.

28. The composition of claim 24 wherein said defined size, defined aspect ratio and said first and second amounts of water are effectively controlled such that said hardened product has a porosity of at most about 75% of said comparative composition.

29. The composition of claim 24 wherein said defined size, defined aspect ratio and said first and second amounts of water are effectively controlled such that said hardened product has a weight of at most about 75% of said comparative composition, a porosity of at most about 75% of said comparative composition, and a compaction test value of at least 50% greater than that of said comparative composition.

30. The composition of claim 24 wherein said defined size, defined aspect ratio and said first and second amounts of water are effectively controlled such that said hardened product has a weight of at most about 75% of said comparative composition, a porosity of at most about 75% of said comparative composition, and a compaction test value of at least 50% greater than that of said comparative composition.

31. A method comprising
(a) a preparation step comprising reduction of a cellulosic fiber material to produce a fiber fragment product;
(b) a treatment step comprising
(1) admixing said fiber fragment product and water to form an admixture,
(2) heating said admixture,
(3) agitating said admixture,
(4) optionally acid-treating said admixture, and
(5) separating a treated fiber fragment product from said admixture; and
(c) a rinsing step comprising rinsing said treated fiber fragment product with water to form a rinsed fiber fragment product,
wherein said steps are effectively controlled so that said rinsed fiber fragment product is suitable for reacting with a cementitious composition to form a product having a compression strength at least equal to about 2,000 pounds pressure per square inch after seven days.

32. The method of claim 31 further comprising
(d) a mixing step comprising
(1) creating an admixture of said rinsed fiber fragment product, a cementitious binder, and water; and
(2) mixing said admixture to produce a mixed mass.

33. The method of claim 32 further comprising a reaction step comprising reacting said mixed mass to create a product comprising reacted rinsed fiber fragment product and cementitious binder.
